(19) United States
(12) Patent Application Publication
(10) Pub. No.: US 2022/0269024 A1
(43) Pub. Date: Aug. 25, 2022

(54) OPTICAL FIBER CABLE WITH DROP CABLES HAVING PREATTACHED OPTICAL CONNECTORS AND METHOD TO STRAND THE SAME

(71) Applicant: CORNING RESEARCH & DEVELOPMENT CORPORATION, Corning, NY (US)

(72) Inventors: Eric Scott Quinby, Granite Falls, NC (US); James Arthur Register, III, Hickory, NC (US)

(21) Appl. No.: 17/740,677

(22) Filed: May 10, 2022

Related U.S. Application Data
(63) Continuation of application No. PCT/US2020/056798, filed on Oct. 22, 2020.
(60) Provisional application No. 62/937,287, filed on Nov. 19, 2019.

(51) Int. Cl. G02B 6/44

(52) U.S. Cl. CPC G02B 6/449; G02B 6/4495; G02B 6/4471

(57) ABSTRACT

An optical fiber carrying structure and a method of making are disclosed. The structure comprises a central core extending from a first end to a second end, and subunits wound around a portion of the central core. The subunits include one or more optical fiber subunits having at least one optical fiber, a connector is attached to an end of the optical fiber subunit, and a filler rod is coupled to the optical fiber subunit.

### CROSS-REFERENCED TO RELATED APPLICATIONS

This application is a continuation of International Application No. PCT/US2020/056798, filed on Oct. 22, 2020, which claims the benefit of priority under 35 U.S.C. § 119 of U.S. Provisional Application Ser. No. 62/937,287 filed on Nov. 19, 2019, the content of which is relied upon and incorporated herein by reference in its entirety.

### BACKGROUND

The present disclosure relates to optical fiber cables and more particularly to optical fiber cables that have drop cables that run along at least a portion of a central core. Optical fiber cables are used to transmit data over distance. Generally, large distribution cables that carry a multitude of optical fibers from a hub are sub-divided at network nodes, which are further sub-divided, e.g., to the premises of individual subscribers. Generally, these subdivisions involve splicing a cable tether into a main distribution line. Cable splicing at specific locations along a main distribution line is a delicate and time consuming process that requires precise placement of the cable tether and involves the risks of cutting the wrong fibers and providing environmental exposure to the cable interior.

### SUMMARY

One embodiment of the disclosure relates to an optical fiber carrying structure, such as an optical fiber cable, including a central core, an optical fiber carrying subunit, a connector coupled to an end of the subunit, and a filler rod. The subunit is wound around the central core and extends a first length of the optical fiber cable. The connector is optically coupled to one end of the subunit that extends laterally outward away from the central core. The filler rod is wound around the central core and extends a second portion of the optical fiber cable. The filler rod does not comprise an optical fiber and the filler rod is coupled to an outer surface of the optical fiber carrying subunit.

In another embodiment the disclosure relates to an optical fiber cable including a central core, an optical fiber carrying subunit, a connector and a filler rod. The subunit is wound around the central core and extends a portion of a distance from the first end of the optical fiber cable to the second end of the optical fiber cable. The connector is optically coupled to one end of the subunit that extends laterally outward away from the central core. The filler rod is coupled to the section of the subunit adjacent to the portion that extends away from the central core. The filler rod and the subunit exert a tensile force on each other.

In yet another embodiment the disclosure relates to a method of manufacturing an optical fiber carrying structure that includes unspooling a central core from a first spool and unspooling a first subunit from a second spool. The first subunit includes an optical fiber carrying subunit, a connector and a filler rod. The connector is optically coupled to one end of the subunit that extends laterally outward away from the central core. The filler rod is coupled to the optical fiber carrying subunit. The first subunit is wound around the central core for at least a portion of the length of the central core.

Additional features and advantages will be set forth in the detailed description that follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding and are incorporated in and constitute a part of this specification. The drawings illustrate one or more embodiment(s), and together with the description serve to explain principles and the operation of the various embodiments.

### BRIEF DESCRIPTION OF THE DRAWINGS

FIG. 1 depicts a partial perspective view of a bundled fiber optical cable, according to an exemplary embodiment.

FIG. 2 depicts a cross-sectional view of the bundled fiber optical cable of FIG. 1.

FIG. 3 depicts a detail view of a drop cable, according to an exemplary embodiment.

FIG. 4 depicts a side view of a subunit cable of the bundled optical cable of FIG. 1, according to an exemplary embodiment.

FIG. 5 depicts a side view of the filler rod of the subunit cable of FIG. 4, according to an exemplary embodiment.

FIG. 6 depicts a side view of a filler rod of a subunit cable, according to an exemplary embodiment.

FIG. 7 depicts a side view of a subunit cable of a bundled fiber optical cable, according to an exemplary embodiment.

FIG. 8 depicts a schematic view of the bundled fiber optical cable of FIG. 1, according to an exemplary embodiment.

FIG. 9 depicts a schematic view of an apparatus and process for forming a bundled fiber optical cable, according to an exemplary embodiment.

FIG. 10 depicts a funneling component for the apparatus and process of FIG. 9, according to an exemplary embodiment.

FIG. 11 depicts a schematic view of an apparatus and process for forming a bundled fiber optical cable, according to an exemplary embodiment.

### DETAILED DESCRIPTION

Referring generally to the figures, various embodiments of a bundled optical fiber cable are provided. The bundled optical fiber cable includes a central core, such as an optical fiber carrying structure, and at least one subunit cable wound around the central core. Unlike other cable tethers, one or more of the subunit cables include a pre-connected connector that is spooled into the bundled optical fiber cable during manufacture. In this way connectorized subunit cables can be stranded with connectors at selected locations along the length of the bundled optical fiber. Filler rods are coupled to the subunit cables adjacent to the end of the subunit cable where the connector is coupled. When forming the bundled optical fiber cable, the filler rod exerts a tensile force on the subunit cable. This approach permits the bundled optical fiber cable to be formed easier and more quickly by enabling the connector to be biased away from the central core during spooling of the subunit cable onto the central core. This biasing of the connector away from the central core reduces the likelihood of the connector interfering with the desired formation of the bundled optical fiber cable.

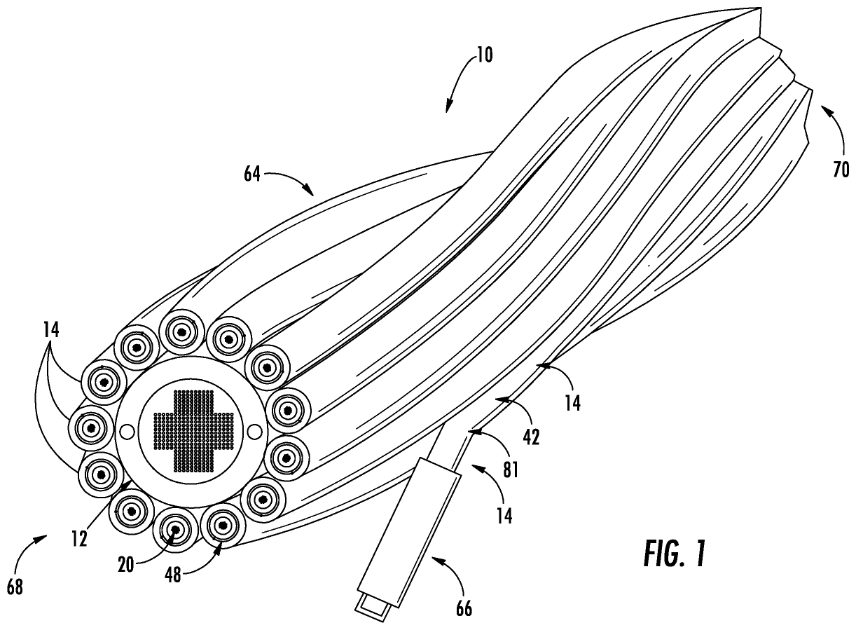

FIG. 1 depicts an embodiment of a bundled optical fiber cable 10 in a perspective cross-sectional view taken perpendicular to a longitudinal axis of the bundled optical fiber cable 10. As can be seen, the bundled optical fiber cable 10 includes a central core, shown as central cable unit 12, and a plurality of optical fiber carrying subunits, shown drop cables 14, that are wound around the outside of the central cable unit 12. In various embodiments, the drop cables 14 are helically wound around the central cable unit 12. For example, in embodiments, the drop cables 14 may have an S winding or a Z winding around the central cable unit 12. Additionally, in embodiments, the drop cables 14 may have an SZ winding around the central cable unit 12.

In various embodiments a section of drop cable 14, shown as connection leg 38, extends outwardly from central cable unit 12 at transition point 81 towards connector 66. First end 76 of drop cable 14 is coupled to connector 66 such that connector 66 is in optical communication with one or more optical fibers 20 within drop cable 14.

Filler rod 48 is helically wound around central cable unit 12 and is coupled to the drop cable 14 adjacent to first end 76 of drop cable 14. The drop cable 14 is wound around central cable unit 12 from second end 70 to transition point 81, and filler rod 48 is wound around central cable unit 12 from transition point 81 to first end 68. Thus, drop cable 14 extends a first portion from first end 68 to second end 70 and filler rod 48 extends a second portion from first end 68 to second end 70, so both drop cable 14 and filler rod 48 extend less than the full distance from first end 68 to second end 70. In one embodiment the first portion over which drop cable 14 extends is distinct from the second portion over which filler rod 48 extends. In one embodiment, one or more filler rods 48 extend from first end 68 of bundled optical fiber cable 10 to second end 70 of bundled optical fiber cable 10.

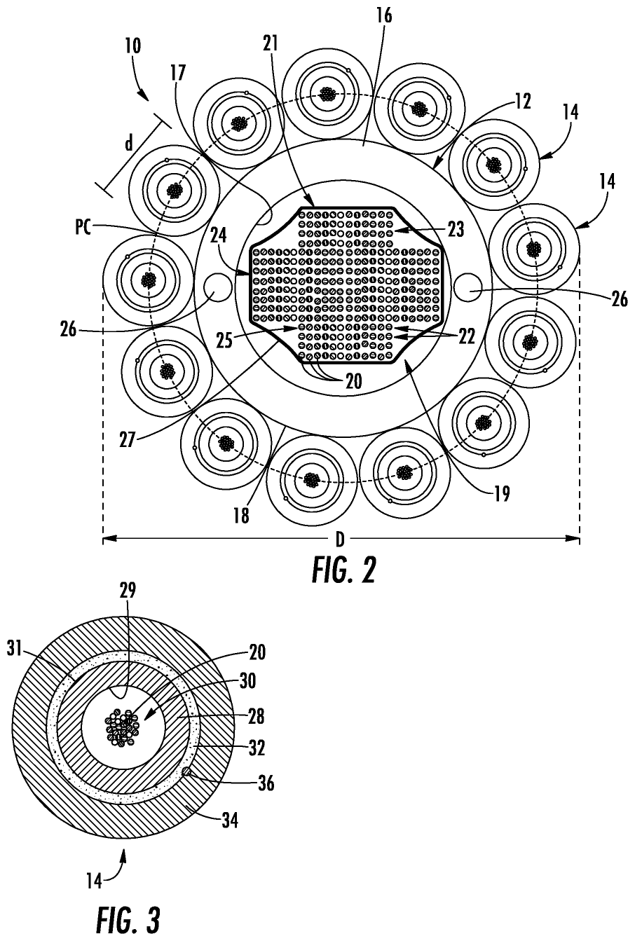

In embodiments, the drop cables 14 are held to the central cable unit 12 only via the winding, which allows the drop cables 14 some degree of movement longitudinally along the length of the central cable unit 12 during bending of the bundled optical fiber cable 10. In embodiments, the laylength of the winding (i.e., the length required for the drop cable 14 to make a complete revolution around the central cable unit 12) is a function of the ratio between the laylength LL and a pitch circle PC (as shown in FIG. 2). With reference to FIG. 2, the pitch circle runs through the center of each drop cable 14 and, thus, has a diameter extending from the center of a first drop cable 14 to the center of a second drop cable 14 directly opposite the first drop cable 14. Therefore, the diameter of the pitch circle is equal to the outer diameter D bundled optical fiber cable 10 minus the outer diameter d of one drop cable 14. In embodiments, the laylength of the drop cables 14 is selected such that the ratio LL/PC is 20 or less. In other embodiments, the laylength of the drop cables 14 is selected such that the ratio LL/PC is 17.5 or less, and in still other embodiments, the laylength is selected such that the ratio LL/PC is 15 or less. A lower laylength corresponds to tighter coils of the drop cables 14 around the central cable unit 12, which increases the length of the drop cables 14 necessary for a given length of the central cable unit. Further, processing line speed is slower at lower laylengths because of the tighter coiling. Thus, in embodiments, the laylength is maintained close to the allowable LL/PC ratio to reduce extra fiber length and to maintain a higher processing line speed.

In embodiments, bands are placed at various intervals along the length of the bundled optical fiber cable 10 to keep the drop cables 14 wrapped around the central cable unit 12. In certain embodiments, the bands are welded polyethylene bands. In another embodiment, webbing, such as a polyethylene web ribbon, is provided around the drop cables 14 to keep the drop cables 14 wrapped around the central cable unit 12.

As will be appreciated from the discussion provided later herein, in embodiments, the drop cables 14 each have different lengths and run only so far as to reach their desired drop location. The central cable unit 12 spans at least as long as the longest drop cable 14. However, each of the drop cables 14 and the central cable unit 12 has substantially the same beginning point. In an embodiment as shown in FIG. 1, drop cables 14 define an outermost surface 64 of cable 10, and in contrast to other cable designs that include an outer cable jacket, cable 10 provides each branching and routing access to drop cables 14 by not including an outer cable jacket.

FIG. 2 provides a detailed cross-sectional view of the bundled optical fiber cable 10. As can be seen, the drop cables 14 are substantially evenly spaced around the circumference of central cable unit 12. In the embodiment depicted, there are thirteen drop cables 14. In embodiments, as few as a single drop cable 14 can be provided around the central cable unit 12. In other embodiments, as many as twenty-four drop cables 14 can be provided around the central cable unit 12. Additionally, the drop cables can include electrical transmission elements, such as wires.

In general, the number of drop cables 14 that can be provided around the central cable unit 12 depends on size of drop cables 14, size of the central cable unit 12, and any external limiting factors for overall size (e.g., a 2″ duct which houses the bundled optical fiber cable 10). In an exemplary embodiment, the central cable unit 12 has an outer diameter of 20 mm, and the drop cables 14 each have an outer diameter d of 4.8 mm. In this exemplary embodiment, fifteen drop cables 14 are able to fit around the central cable unit 12. The outer diameter D of the bundled optical fiber cable 10 according to this exemplary embodiment is approximately 30 mm.

As used herein, the diameter D referenced with respect to the embodiment of FIG. 2 refers to the diameter of a hypothetical circle defined by the outermost extents of the drop cables 14. As viewed from the cross-section of FIG. 2, the bundled optical fiber cable 10 is defined by a larger, central circle surrounded by smaller, outer circles. Thus, the actual outermost surface of the bundled optical fiber cable 10 undulates moving from drop cable 14 to drop cable 14 around the circumference. Accordingly, the actual cross-sectional width of the bundled optical fiber cable 10 varies at different positions measured around the circle.

Referring now to the structure of the bundled optical fiber cable 10 as shown in FIG. 2, the central cable unit 12 includes a cable jacket 16 having an inner surface 17 and an outer surface 18. The inner surface 17 defines a cable bore 19 within which a plurality of optical fibers 20 are disposed. The optical fibers 20 can be arranged in a variety of suitable ways within the central cable unit 12. In the embodiment depicted, the optical fibers 20 are arranged in a stack 21 of multiple ribbons 22. In particular, the optical fibers 20 are arranged into a stack 21 of sixteen ribbons 22 having a plus-shaped cross-section. The sixteen ribbons 22 include an upper stack section 23, a middle stack section 24, and a lower stack section 25. In embodiments, the upper stack section 23 and the lower stack section 25 contain the same number of optical fibers 20 and/or ribbons 22. Also, in embodiments, the middle stack section 24 includes at least twice the number of optical fibers 20 per ribbon 22 as compared to the upper stack section 23 and/or the lower stack section 25. Further, in embodiments, the middle stack section includes as least twice as many ribbons 22 as compared to the upper stack section 23 and/or the lower stack section 25. In an exemplary embodiment shown in FIG. 2, the upper stack section 23 and the lower stack section 25 each have four ribbons 22 of twelve optical fibers 20. The middle stack section 24 in the embodiment depicted has eight ribbons 22 of twenty-four optical fibers 20. Thus, in the embodiment depicted, the total number of optical fiber 20 is 288. In embodiments, a single stack can contain up to 864 optical fibers 20. As shown in FIG. 2, the stack 21 is surrounded by a stack jacket 27, which, in embodiments, may provide color coding for multiple-stack configurations and/or water-blocking properties.

In an alternate embodiment, the central core of the bundled optical fiber cable does not include any optical fibers 20. Instead the central core comprises a jacket and optionally also comprises one or more strength members.

In embodiments, multiple stacks 21 can be provided in the cable bore 19. In an exemplary embodiment, the cable bore 19 contains six stacks 21 of 288 optical fibers 20 for a total of 1728 optical fibers 20. In another embodiment, the cable bore 19 contains twelve stacks 21 of 288 optical fibers 20 for a total of 3456 optical fibers 20. In embodiments having multiple stacks 21, the stacks 21 may be wound around a central strengthening member, such as a glass-reinforced plastic member. As will be understood, the number of optical fibers 20 provided in the central cable unit 12 has a bearing on the overall size of the bundled optical fiber cable 10. Thus, the number of optical fibers 20 that can be included in the central cable unit 12 may be dictated by the particular installation parameters. Central core of the type described are available from Corning Incorporated, Corning, N.Y., such as those marketed under the trademark RocketRibbon™.

Moreover, while FIG. 2 depicts the optical fibers 20 arranged in ribbons 22 that are further arranged into stacks 21, the cable bore 19 could instead include a plurality of loose optical fibers 20 or a plurality of optical fibers 20 grouped into multiple buffer tubes. In the latter embodiment, the optical fibers 20 in the buffer tubes can, for example, be arranged in ribbons 22, or the optical fibers 20 can, for example, be in a loose tube configuration. Further, each buffer tube can contain the same or a different number of optical fibers 20. Central cable unit 12 of the type described in this paragraph are available from Corning Incorporated, Corning, N.Y., such as those marketed under the trademarks ALTOS®, SST-Ribbon™, and SST-UltraRibbon™. Additionally, in embodiments, the central cable unit 12 is configured to have a small diameter D for installation in small ducts (e.g., 2″ or less). Such central cable units 12 of this type are available from Corning Incorporated, Corning, N.Y. under the trademark MiniXtend®.

As can also be seen in the embodiment of FIG. 2, the cable jacket 16 includes two strength members 26. In embodiments, each strength member 26 is made of glass-reinforced plastic or metal. Further, while two strength members 26 are depicted, embodiments of the central cable unit 12 can include no strength members 26 or up to four strength members 26. In embodiments, an additional toning member may be embedded in the cable jacket 16 along with the strength members 26. The toning member is selected to be metal to allow for cable location via toning, which is a technique where a signal is sent over the toning member of a buried optical fiber cable such that the signal can be detected above ground for the purpose of locating the optical fiber cable.

FIG. 3 depicts an embodiment of a subunit cable 14. In the embodiment depicted in FIG. 3, the drop cable 14 is a loose tube cable in which the optical fibers 20 are contained in a buffer tube 28. The buffer tube 28 has an interior surface 29 defining a bore 30 in which the optical fibers 20 are contained, and the buffer tube 28 has an exterior surface 31 around which strengthening yarns 32 may optionally be wound. The drop cable 14 also includes a jacket 34 around the buffer tube 28. In embodiments, a ripcord 36 is embedded in the jacket 34 to provide access to the interior of the subunit cable 14.

In the embodiment shown in FIG. 3, the drop cable 14 includes twenty-four optical fibers 20. However, the drop cable 14 can include, e.g., from one optical fiber 20 up to thirty-six optical fibers 20 in embodiments depending on the particular needs of the installation. Further, the drop cable 14 depicted in FIG. 3 is a loose tube cable. In other embodiments, the optical fibers 20 are arranged in one or more ribbons within the buffer tube 28.

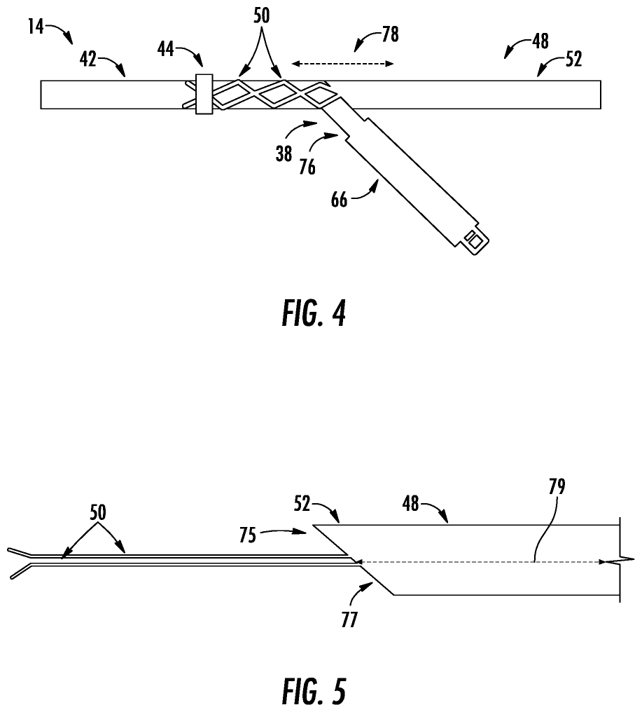

Referring to FIGS. 4 and 5, various aspects of drop cable 14 and filler rod 48 are shown. Filler rod 48 is coupled to drop cable 14 via elongate structures, shown as strands, or more particularly shown as yarn strands 50. In one embodiment yarn strands 50 are elongate strands formed from aramid fibers. In one embodiment two yarn strands 50 are helically wrapped around outer surface 42 of drop cable 14. In one embodiment, yarn strands 50 are wrapped in opposing helical directions around outer surface 42 of drop cable 14. In one embodiment yarn strands 50 are affixed to outer surface 42 via a connector, shown as tape 44.

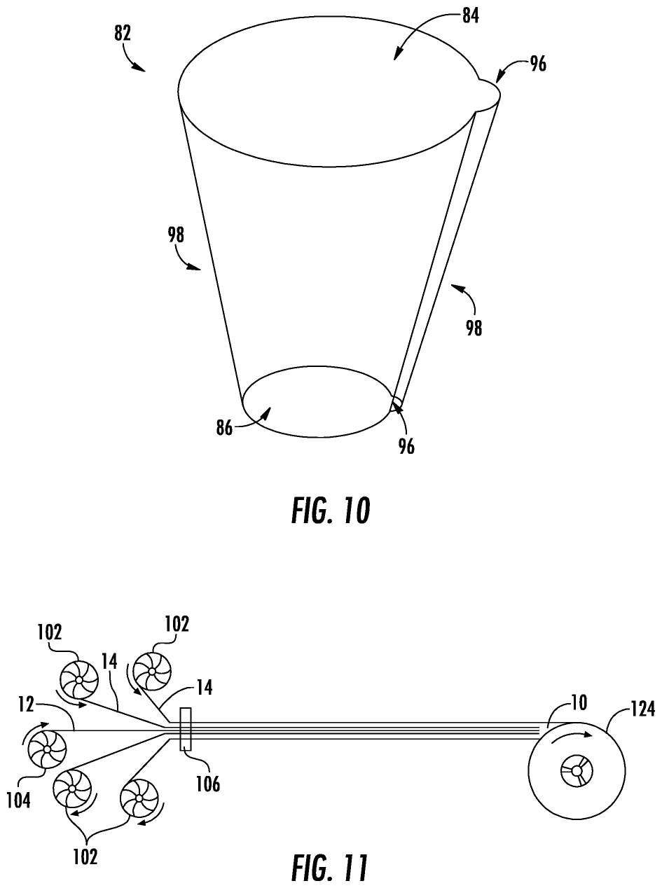

Yarn strands 50 exert a tensile force on filler rod 48 and drop cable 14 when filler rod 48 and drop cable 14 are wound around central cable unit 12. In one embodiment yarn strands 50 communicate a tensile force between drop cable 14 and filler rod 48. The tensile force communicated between filler rod 48 and drop cable 14 facilitates forming bundled optical fiber cable 10 by causing funnel 82 to bias connector 66 away from central cable unit 12 as drop cable 14 and filler rod 48 are being wound around central cable unit 12 (as shown in FIGS. 9 and 10). Additionally, the tensile force communicated between filler rod 48 and drop cable 14 biases filler rod 48 and drop cable 14 towards remaining wound around central cable unit 12.

Connection leg 38 of drop cable 14 extends away from central cable unit 12 until first end 76 of drop cable 14 is coupled to connector 66. Connector 66 is communicatively coupled to optical fiber 20 within drop cable 14 (e.g., in optical communication with) to facilitate communicatively coupling drop cable 14 to another cable, such as another optical fiber cable. In one embodiment connector 66 has a diameter of 12 mm.

In one embodiment, connection leg 38 is 10 feet for aerial connections, 15 feet for duct connections, and 20 feet for other situations. In another embodiment connection leg 38 is lengthened by severing filler rod 48 from drop cable 14 (e.g., by severing yarn strands 50), and then unwinding drop cable 14 from central cable unit 12 until connection leg 38 is the desired length. In a specific embodiment a band is coupled around the one or more drop cables 14 to prevent the one or more drop cables 14 from unwinding further from central cable unit 12. In various embodiments when connectors 66 coupled to various drop cable 14 are proximate each other, connectors 66 are arranged tip to boot, which is to say that the front of a first connector 66 is proximate the back of the next connector 66.

Turning to FIG. 5, tapered end 75 of jacket 52 of filler rod 48 is angled to facilitate coupling filler rod 48 to drop cable 14. Tapered end 75 defines a surface 77 that is angled relative to the longitudinal axis 79 of filler rod 48, and surface 77 interfaces against outer surface 42 of drop cable 14. In one embodiment, two or more yarn strands 50 extend from a central portion of filler rod 48.

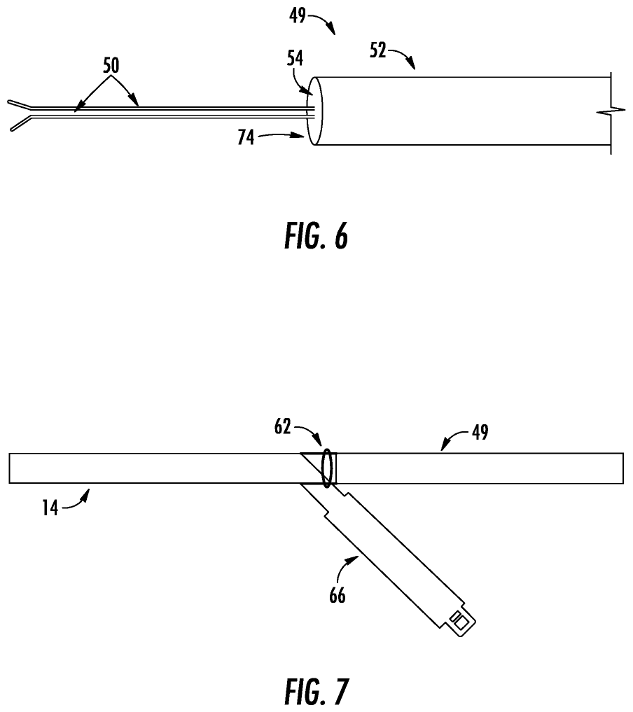

Turning to FIG. 6, in another embodiment filler rod 49 has a flat end 74. Filler rod 49 is substantially the same as filler rod 48 except for end 74 being perpendicular and/or mostly perpendicular to longitudinal axis 79 of filler rod 49. In various embodiments, a filler, shown as foamed polyethylene 54, is within the central portion of filler rod 49 and filler rod 48. One or more yarn strands 50 are coupled to foamed polyethylene 54 and extend outwardly from end 74.

Turning to FIG. 7, filler rod 49 is coupled to drop cable 14 via a connector, shown as swivel 62. Swivel 62 permits axial rotation of filler rod 49 and drop cable 14 with respect to each other. In one embodiment swivel 62 permits unlimited axial rotation of filler rod 49 and drop cable 14 with respect to each other.

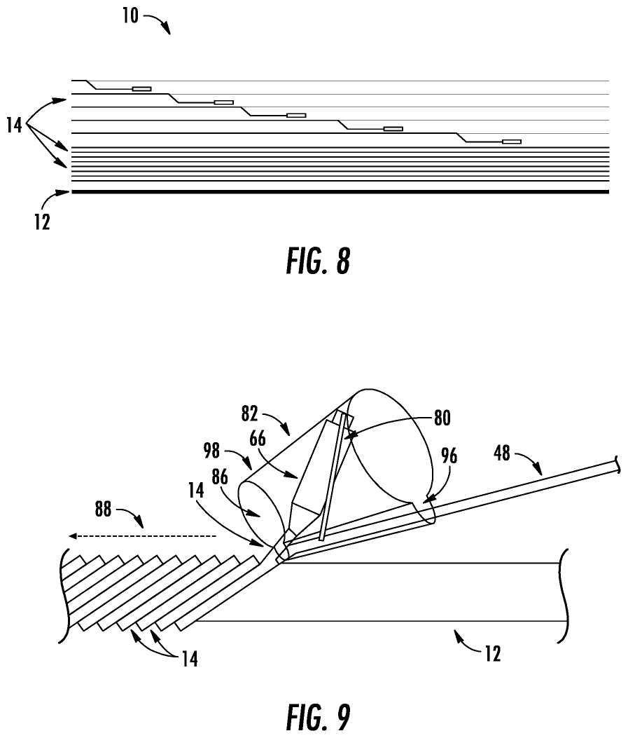

Turning to FIG. 8, various aspects of cable 10 are shown. Drop cable 14 terminate at various locations along cable 10, whereas central cable unit 12 extends through cable 10. In one embodiment anywhere from one to all of drop cables 14 terminate before the end of cable 10.

Turning to FIGS. 9 and 10, various aspects of forming cable 10 are shown. One or more drop cables 14 are spooled around central cable unit 12. In one embodiment, drop cables 14 are helically spooled around central cable unit 12 such that drop cables 14 maintain a constant circumferential position with respect to each other around central core.

Drop cable 14 is fed through funnel 82 in direction 88. Sidewalls 98 of funnel 82 define a channel 96 through which drop cable 14 passes. The tensile force within drop cable 14 forces drop cable 14 towards the bottom of funnel 82, as shown from FIG. 9, towards channel 96. Channel 96 is sized to be smaller than connector 66. As a result, funnel 82 generally and channel 96 in particular biases connector 66 away from central cable unit 12, thereby reducing the likelihood that connector 66 will interfere with drop cable 14 being spooled against central cable unit 12. In a specific embodiment, sidewalls 98 of funnel 82 extend into sidewalls of channel 96 so that no angle is formed between the primary body of funnel 82 and channel 96.

After drop cable 14 is spooled against central core, connector 66 passes through second opening 86 of funnel 82. Filler rod 48 now spools against central cable unit 12 while connector 66 extends outwardly from central cable unit 12. In one embodiment connector 66 is coupled to filler rod 48 via a connection, shown as stretchable fabric 80.

Turning to FIG. 11, depicted is a schematic view of an apparatus and process for forming a cable according to this disclosure. Initially, central cable unit 12 is spooled around spool 104, and one or more drop cables 14 are spooled around spools 102. Drop cables 14 and central cable unit 12 are spooled towards closing point 106 where drop cables 14 are wound around central cable unit 12. Central cable unit 12 and the one or more drop cables 14 are moved towards and wound around spool 124.

In one embodiment spool 104 is axially rotated so that central cable unit 12 rotates as it approaches closing point 106, whereas drop cables 14 are kept stationary. As a result, drop cables 14 are helically wound around central cable unit 12. In another embodiment spools 102 for drop cables 14 are rotated around central cable unit 12.

At closing point 106, funnel 82 is held in place near central cable unit 12 to permit drop cable 14 to transit into first opening 84 and out of second opening 86. In one embodiment funnel 82 is restrained by a donut that is affixed around sidewalls 98, permitting funnel 82 to axially rotate while drop cable 14 transits funnel 82 towards central cable unit 12. Permitting funnel 82 to rotate allows the tensile force on drop cable 14 to bias funnel 82 so that channel 96 extends towards central cable unit 12. As described above, this positioning of channel 96 helps protect connector 66 from interfering with the placement of drop cable 14 on central cable unit 12.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. An optical fiber carrying structure comprising:
a central core extending in a longitudinal direction from a first end to a second end;
an optical fiber subunit comprising an optical fiber, the optical fiber subunit wound around the central core and extending a first partial portion of the distance from the first end of the optical fiber carrying structure to the second end of the optical fiber carrying structure, wherein a first end of the optical fiber subunit extends laterally outward away from the central core;
a connector attached to the first end of the optical fiber subunit, wherein the connector terminates the optical fiber of the optical fiber subunit; and
a filler rod wound around a portion of the central core and extending a second partial portion of the distance from the first end of the optical fiber carrying structure to the second end of the optical fiber carrying structure, wherein the filler rod does not comprise an optical fiber, and wherein the filler rod is coupled to an outer surface of the optical fiber subunit.

2. The optical fiber carrying structure of claim 1, further comprising a plurality of optical fiber subunits that comprise the optical fiber subunit and each of the plurality of optical fiber subunits comprises an optical fiber, wherein the plurality of optical fiber subunits are helically wound around the central core.

3. The optical fiber carrying structure of claim 2, wherein the plurality of optical fiber subunits are each coupled to a distinct connector at an end of the respective optical fiber subunit, and wherein each distinct connector terminates the respective optical fiber of the respective optical fiber subunit.

4. The optical fiber carrying structure of claim 1 further comprising:
a yarn strand extending from the filler rod and coupled to the optical fiber subunit.

5. The optical fiber carrying structure of claim 4, further comprising a fastener that couples the yarn strand the optical fiber subunit.

6. The optical fiber carrying structure of claim 5, wherein the fastener comprises a tape.

7. The optical fiber carrying structure of claim 1, wherein the filler rod defines an outer surface that is angled relative to a longitudinal axis of the filler rod, and wherein the angled outer surface interfaces against the outer surface of the optical fiber subunit.

8. The optical fiber carrying structure of claim 1, further comprising a first yarn strand and a second yarn strand extending from the filler rod and coupled to the optical fiber subunit, wherein the first yarn strand is helically wound around a portion of an outer surface of the fiber optic subunit in a first direction and the second yarn strand is helically wound around the outer surface of the fiber optic subunit in a second direction that is opposite the first direction.

9. The optical fiber carrying structure of claim 1, wherein the central core comprises at least one strengthening member, and wherein the central core does not comprise an optical fiber.

10. The optical fiber carrying structure of claim 1, wherein the central core comprises at least one optical fiber.

11. An optical fiber carrying structure comprising:
a central core extending from a first end of the optical fiber carrying structure to a second end of the optical fiber carrying structure;
an optical fiber subunit comprising an optical fiber, the optical fiber subunit wound around the central core and extending a partial portion of a distance from the first end of the optical fiber carrying structure to the second end of the optical fiber carrying structure, wherein a section of the optical fiber subunit extends laterally outward away from the central core;
a connector coupled to a first end of the optical fiber subunit, wherein the connector terminates the optical fiber in the optical fiber subunit; and
a filler rod coupled to the section of the optical fiber subunit adjacent to the first end of optical fiber subunit such that the filler rod and the optical fiber subunit exert a tensile force on each other.

12. The optical fiber carrying structure of claim 11, wherein the optical fiber subunit defines at least a portion of an outermost surface of the optical fiber carrying structure.

13. The optical fiber carrying structure of claim 11, wherein the first end of the optical fiber subunit extends outwardly away from the central core.

14. The optical fiber carrying structure of claim 11, further comprising a swivel that is coupled to both the optical fiber subunit and the filler rod, wherein the swivel permits axial rotation between the optical fiber subunit and the filler rod.

15. The optical fiber carrying structure of claim 10, further comprising a yarn strand coupled to the filler rod, wherein the filler rod is coupled to the optical fiber subunit via the yarn strand.

16. A method of manufacturing an optical fiber carrying structure, the method comprising:
unspooling a central core from a first spool;
unspooling a first optical fiber subunit from a second spool, wherein the first optical fiber subunit comprises:
an optical fiber;
a connector coupled to a first end of the optical fiber subunit, wherein the connector is attached the optical fiber of the optical fiber subunit; and
a filler rod coupled to the first optical fiber subunit; and
winding the first optical fiber subunit around a portion of the central core.

17. The method of claim 16, wherein winding the first optical fiber subunit around the central core comprises:
winding the filler rod around a portion of the central core subsequent to winding the first optical fiber subunit around a portion of the central core.

18. The method of claim 16, further comprising:
passing the first optical fiber subunit through a funnel, wherein the funnel defines a first opening and a second opening that defines a smaller area than the first opening, and wherein the first optical fiber subunit enters the funnel via the first opening and exits the funnel via the second opening.

19. The method of claim 18, wherein the funnel further defines a channel in a sidewall, and wherein the channel extends from the first opening to the second opening.

20. The method of claim 16, further comprising:
unspooling a second optical fiber subunit from a third spool, wherein the second optical fiber subunit comprises:
a second optical fiber;
a connector coupled to a first end of the second optical fiber subunit, wherein the connector is attached to the optical fiber of the second optical fiber subunit; and
a second filler rod coupled to the second optical fiber subunit; and
winding the second optical fiber subunit around a portion of the central core, wherein the second optical fiber subunit is disposed at a predetermined circumferential position with respect to the first optical fiber subunit.
